(19) United States
(12) Patent Application Publication
(10) Pub. No.: US 2026/0309929 A1
(43) Pub. Date: Oct. 8, 2026

(54) OPTICAL INTERCONNECT WITH TANDEM FERRULE

(71) Applicant: 3M INNOVATIVE PROPERTIES COMPANY, St. Paul, MN (US)

(72) Inventors: David B. Stegall, St. Paul, MN (US); Ethan R. Rosenberg, St. Paul, MN (US)

(21) Appl. No.: 19/484,452

(22) PCT Filed: May 8, 2024
(86) PCT No.: PCT/IB2024/054496

§ 371 Date: Nov. 14, 2025

Related U.S. Application Data
(60) Provisional application No. 63/468,327, filed on May 23, 2023.

(51) Int. Cl. G02B 6/38

(52) U.S. Cl. CPC G02B 6/3885; G02B 6/3838

(57) ABSTRACT

An optical ferrule (400) includes first (110a) and second (110b) rows of respective first (11a) and second (111b) receiving elements, first (130a) and second (130b) input members offset relative to each other along a length direction, first (140a) and second (140b) light redirecting members, and an exit window (250). The second row (110b) of the second receiving elements (111b) is offset in a thickness direction of the ferrule (400) relative to the first row (110a) of the first receiving elements (11a). When first (120a) and second (120b) optical fibers are received by and secured in the respective first and second receiving elements, first and second central light rays emitted by the respective first and second optical fibers (120a, 120b) enter the unitary optical ferrule through the respective first (130a) and second (130b) input members. The entered first and second central light rays are redirected by the first and second light redirecting members (140a, 140b), and the redirected first and second central light rays exit the unitary optical ferrule (400) through the exit window (250).

### SUMMARY

In some aspects of the present description, a unitary optical ferrule is provided, the unitary optical ferrule including a plurality of rows including at least first and second rows of respective substantially parallel first and second receiving elements, first and second input members, first and second light redirecting members, and an exit window. The first and second rows of respective substantially parallel first and second receiving elements extend along a same length direction and are arranged along an orthogonal same width direction and are configured for receiving and securing respective first and second optical fibers. The second row of the second receiving elements is offset relative to the first row of the first receiving elements along a thickness direction orthogonal to the length and width directions. The first and second input members are offset relative to each other along the length direction. When the first and second optical fibers are received by and secured in the respective first and second receiving elements, first and second central light rays emitted by the respective first and second optical fibers enter the unitary optical ferrule through the respective first and second input members. The entered first and second central light rays are redirected by the respective first and second light redirecting members from first directions to different second directions, and the redirected first and second central light rays exit the unitary optical ferrule through the exit window.

In some aspects of the present description, a unitary optical ferrule is provided, the unitary optical ferrule including a first receiving element for receiving and securing a first optical fiber, a first input member, a first light redirecting member, and an exit window. When the first optical fiber is received by and secured in the first receiving element, a first central light ray emitted by the first optical fiber enters the unitary optical ferrule through the first input member. The entered first central light ray is redirected by the first light redirecting member from a first direction to a different second direction, and the redirected first central light ray exits the unitary optical ferrule through the exit window. The first input and light redirecting members define a recess therebetween, and wherein the entered first central light ray passes through the recess before being redirected by the first light redirecting member.

In some aspects of the present description, a unitary optical fiber is provided, the unitary optical ferrule including first and second receiving elements for receiving and securing respective first and second optical fibers, first and second input members, first and second light redirecting members, and an exit window. When the first and second optical fibers are received by and secured in the respective first and second receiving elements, first and second central light rays emitted by the respective first and second optical fibers enter the unitary optical ferrule through the respective first and second input members. The entered first and second central light rays are redirected by the respective first and second light redirecting members from first directions to different second directions, and the redirected first and second central light rays exit the unitary optical ferrule through the exit window. The first input and first light redirecting members define a recess therebetween. An inner wall of the recess includes the second light redirecting member.

In some aspects of the present description, a unitary optical fiber is provided, the unitary optical ferrule including a plurality of rows having at least first and second rows of respective substantially parallel first and second receiving elements, first and second input members, a plurality of first light redirecting members alternating with a plurality of second light redirecting members, and an exit window. The first and second rows of respective substantially parallel first and second receiving elements extend along a same length direction and are arranged along an orthogonal same width direction for receiving and securing respective first and second optical fibers. The second row of the second receiving elements is offset relative to the first row of the first receiving elements along a thickness direction orthogonal to both the length and width directions. The first and second input members are offset relative to each other along the length direction. Each second light redirecting member is disposed in a recess relative to each corresponding first light redirecting member. When the first and second optical fibers are received by and secured in the respective first and second receiving elements, first and second central light rays emitted by the respective first and second optical fibers enter the unitary optical ferrule through the respective first and second input members. The entered first and second central light rays are redirected by the respective first and second light redirecting members from first directions to different second directions. The redirected first and second central light rays exit the unitary optical ferrule through the exit window. Each of the redirected first and second central light rays exiting the unitary optical ferrule through the exit window are substantially disposed in a same first plane.

### BRIEF DESCRIPTION OF THE DRAWINGS

FIGS. 1A-1C illustrate a typical I/O port spacing in the prior art, and two examples of a multi-row spacing, in accordance with an embodiment of the present description;

FIGS. 2A and 2B are perspective views of a tandem optical ferrule, in accordance with an embodiment of the present description;

FIGS. 3A and 3B provide perspective views of a tandem optical ferrule, in accordance with an alternate embodiment of the present description;

FIGS. 4A and 4B provide further perspective views of a tandem optical ferrule, in accordance with embodiments of the present description;

FIGS. 5A and 5B provide side, cutaway views of a tandem optical ferrule, in accordance with an embodiment of the present description;

FIGS. 6A and 6B provide side, cutaway views of a tandem optical ferrule, in accordance with an alternate embodiment of the present description;

FIG. 7 illustrates the angle of incidence of central light rays on the input member of an optical ferrule, in accordance with an embodiment of the present description;

FIGS. 8A and 8B provide perspective views of a tandem optical ferrule, in accordance with another alternate embodiment of the present description;

FIGS. 9A and 9B provide additional perspective views of a tandem optical ferrule, in accordance with the alternate embodiment of FIGS. 8A and 8B;

FIGS. 10A-10C provide side, cutaway views of a tandem optical ferrule, in accordance with the alternate embodiment of FIGS. 8A and 8B; and

FIG. 11 is a cutaway, perspective view of a tandem optical ferrule, in accordance with the alternate embodiment of FIGS. 8A and 8B.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

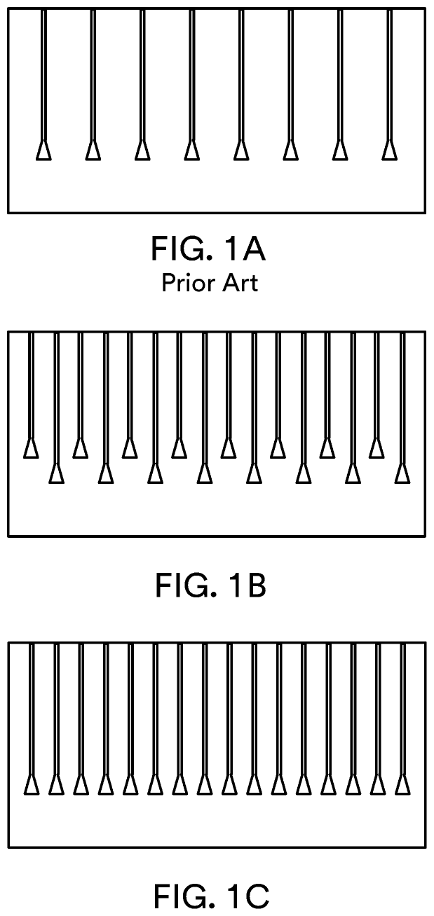

Ever increasing data communication bandwidth specifications for photonic integrated circuits (PICs) will necessitate more input/out (I/O) ports. Current I/O arrays exhibit a single row of ports, as shown in FIG. 1A. However, limited PIC area will drive designers to increase the density of these arrays. One solution to increasing the density of the arrays is to decrease the spacing between waveguides (e.g., decreasing the channel pitch of the I/O port array). Examples of how this might be done is to add a second row of I/O ports to the first row, as shown in FIGS. 1B and 1C, which would effectively double the number of channels available compared to the one-row array. In the embodiment of FIG. 1B, the second row of I/O ports may be offset from the first row of I/O ports. In the embodiment of FIG. 1C, the second row of I/O ports may not be offset, but simply added in line with the existing I/O ports.

According to some aspects of the present description, embodiments of unitary optical ferrules are herein described which are configured to interface with the increased number of I/O ports that will be seen in photonic integrated circuits going forward. For example, in some embodiments, a unitary optical ferrule is provided, the unitary optical ferrule including a plurality of rows having at least first and second rows of respective substantially parallel first and second receiving elements, first and second input members offset relative to each other along the length direction, first and second light redirecting members, and an exit window.

In some embodiments, the first and second receiving elements may extend along a same length direction (e.g., along an x-axis of the ferrule) and arranged along an orthogonal same width direction (e.g., along a y-axis) for receiving and securing respective first and second optical fibers. In some embodiments, the second row of the second receiving elements may be offset relative to the first row of the first receiving elements along a thickness direction (e.g., along a z-axis) orthogonal to the length and width directions.

In some embodiments, when the first and second optical fibers are received by and secured in the respective first and second receiving elements, first and second central light rays emitted by the respective first and second optical fibers may enter the unitary optical ferrule through the respective first and second input members. In some embodiments, the entered first and second central light rays may be redirected by the respective first and second light redirecting members from first directions to different second directions, and the redirected first and second central light rays exit the unitary optical ferrule through the exit window.

In some embodiments, a distance traveled by the entered first central light ray between the first input and light redirecting members is S1 and a distance traveled by the entered second central light ray between the second input and light redirecting members is S2. In some embodiments, S1 and S2 may be within 20%, or within 15%, or within 10%, or within 5% of each other, or S1 and S2 may be substantially equal.

In some other embodiments, a distance traveled by the entered first central light ray between the first input and light redirecting members is S11 and a distance traveled by the entered second central light ray between the second input and light redirecting members is S12. In some embodiments, S11 and S12 may be different by at least 30%, or at least 40%, or at least 50%, or at least 60%, or at least 70%, or at least 80%, or at least 90%, or at least 100%.

In some embodiments, wherein the second row of the second receiving elements may be offset relative to the first row of the first receiving elements along the thickness direction by at least 5 microns, or at least 10 microns, or at least 20 microns, or at least 50 microns, or at least 100 microns, or at least 150 microns, or at least 200 microns.

In some embodiments, each of the first and the second rows includes at least two receiving elements, or at least five receiving elements, or at least ten receiving elements. In some embodiments, each of the first and second receiving elements may include a groove extending along the length direction.

In some embodiments, the first and the second input members may be offset relative to each other along the length direction by at least 10 microns, or at least 50 microns, or at least 100 microns, or at least 500 microns, or at least 1000 microns, or at least 2000 microns, or at least 5000 microns.

In some embodiments, the first and the second light redirecting members may be offset relative to each other along the length direction and along the thickness direction. In some embodiments, the entered first and second central light rays are redirected by the respective first and second light redirecting members by at least 40 degrees, or at least 50 degrees, or at least 60 degrees, or at least 70 degrees, or at least 80 degrees. In some embodiments, the corresponding first and second directions make an angle of between about 30 degrees and about 150 degrees therebetween.

In some embodiments, the unitary optical ferrule may further include a bottom surface opposite and substantially parallel to the first and the second rows. In some embodiments, the bottom surface includes the exit window. In some embodiments, each of the redirected first and second central light rays may exit the unitary optical ferrule through the exit window at a different location of the exit window. In some embodiments, the exit window may include an anti-reflection coating disposed thereon to reduce a reflection of an incident light having a wavelength of greater than about 500 nm, or greater than about 600 nm, or greater than about 700 nm, or greater than about 800 nm, or greater than about 900 nm, or greater than about 1000 nm by at least 1%, or at least 2%, or at least 3% In some embodiments, each of the central light rays emitted by the first and second optical fibers may be incident on the corresponding input member at an incident angle of greater than about 0.5 degrees, or greater than about 1 degree, or greater than about 1.5 degrees, or greater than about 2 degrees, or greater than about 3 degrees, or greater than about 4 degrees, or greater than about 5 degrees.

In some embodiments, an average size of the first light redirecting members and an average size of the second light redirecting members may be different by at least 10%, or at least 20%, or at least 25%, or at least 30%, or at least 35%, or at least 50%, or at least 100%, or at least by a factor of 3, or at least by a factor of 4.

In some embodiments, each of the redirected first and second central light rays exiting the unitary optical ferrule through the exit window may be substantially disposed in a same first plane. In some embodiments, a center point of each of the first and the second light redirecting members may be contained within a same second plane, the second plane substantially orthogonal to a surface of each of the first and second light redirecting members.

In some embodiments, the second light redirecting members may alternate with the first light redirecting members across the width direction of the optical ferrule, and each of the second light redirecting members may be disposed in a recess relative to the each of the first light redirecting members.

According to some aspects of the present description, a unitary optical ferrule includes a first receiving element for receiving and securing a first optical fiber, a first input member, a first light redirecting member, and an exit window. In some embodiments, when the first optical fiber is received by and secured in the first receiving element, a first central light ray emitted by the first optical fiber may enter the unitary optical ferrule through the first input member. In some embodiments, the entered first central light ray may be redirected by the first light redirecting member from a first direction to a different, second direction. In some embodiments, the redirected first central light ray may exit the unitary optical ferrule through the exit window. In some embodiments, the first input member and the first light redirecting member may define a recess therebetween, and the entered first central light ray may pass through the recess before being redirected by the first light redirecting member.

In some embodiments, the unitary optical ferrule may have a first composition, and the recess may be filled with a different, second composition. In some such embodiments, the first composition may include one or more of a polymer, a ceramic, a glass, alumina, fused silica, titania, and zirconia. In some such embodiments, the second composition may include air. In some embodiments, for at least a same first wavelength in a wavelength range extending from about 400 nm to about 2000 nm, an index of refraction of the first composition may be greater than an index of refraction of the second composition by at least about 0.05, or at least about 0.1, or at least about 0.15, or at least about 0.2, or at least about 0.3, or at least about 0.4.

According to some aspects of the present description, a unitary optical ferrule may include first and second receiving elements for receiving and securing respective first and second optical fibers, first and second input members, first and second light redirecting members, and an exit window. In some embodiments, when the first and second optical fibers are received by and secured in the respective first and second receiving elements, first and second central light rays emitted by the respective first and second optical fibers may enter the unitary optical ferrule through the respective first and second input members. In some embodiments, the entered first and second central light rays are redirected by the respective first and second light redirecting members from first directions to different second directions. In some embodiments, the redirected first and second central light rays exit the unitary optical ferrule through the exit window. In some embodiments, the first input and light redirecting members define a recess therebetween, and an inner wall of the recess includes the second light redirecting member.

According to some aspects of the present description, a unitary optical ferrule includes a plurality of rows having at least first and second rows of respective substantially parallel first and second receiving elements, first and second input members offset relative to each other along the length direction, a plurality of first light redirecting members alternating with a plurality of second light redirecting members, and an exit window. In some embodiments, the first and second receiving elements may extend along a same length direction (e.g., an x-axis of the optical ferrule) and arranged along an orthogonal same width direction (e.g., along a y-axis). In some embodiments, the first and second receiving elements may be configured for receiving and securing respective first and second optical fibers. In some embodiments, the second row of the second receiving elements may be offset relative to the first row of the first receiving elements along a thickness direction (e.g., along a z-axis of the optical ferrule) orthogonal to the first and second directions.

In some embodiments, each second light redirecting member of the plurality of second light redirecting members may be disposed in a recess relative to each corresponding first light redirecting member of the plurality of first light redirecting members.

In some embodiments, when the first and second optical fibers are received by and secured in the respective first and second receiving elements, first and second central light rays emitted by the respective first and second optical fibers may enter the unitary optical ferrule through the respective first and second input members. In some embodiments, the entered first and second central light rays may be redirected by the respective first and second light redirecting members from first directions to different second directions. In some embodiments, the redirected first and second central light rays may exit the unitary optical ferrule through the exit window such that each of the exiting first and second central light rays are substantially disposed in a same first plane (an exit plane). In some embodiments, a center point of each of the first and the second light redirecting members may be contained within a same second plane, the second plane substantially orthogonal to a surface of each of the first and second light redirecting members.

In some embodiments, an average size of the first light redirecting members and an average size of the second light redirecting members may be different by at least 10%, or at least 20%, or at least 25%, or at least 30%, or at least 35%, or at least 50%, or at least 100%, or at least by a factor of 3, or at least by a factor of 4.

Turning now to the figures, FIGS. 1A-1C illustrate a typical I/O port spacing in the prior art, and two examples of multi-row spacing which may be used with embodiments of the present description. FIGS. 1A-1C are discussed elsewhere herein.

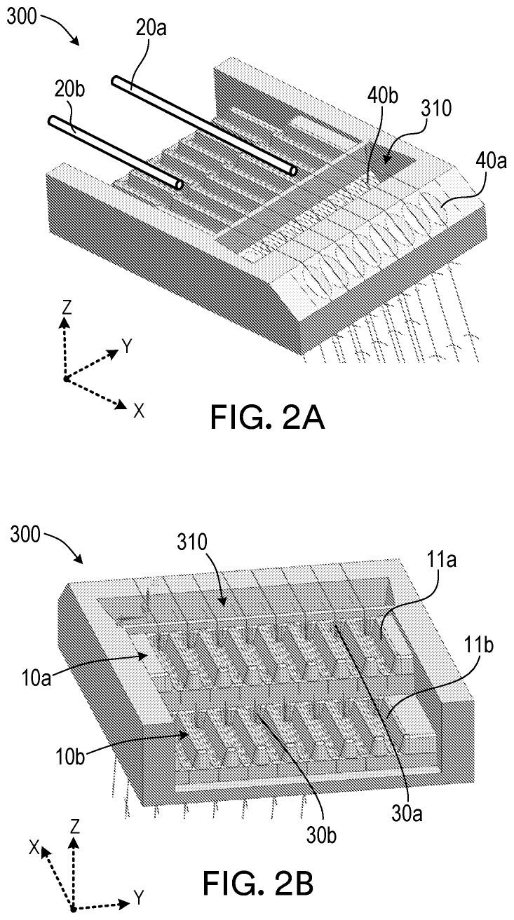

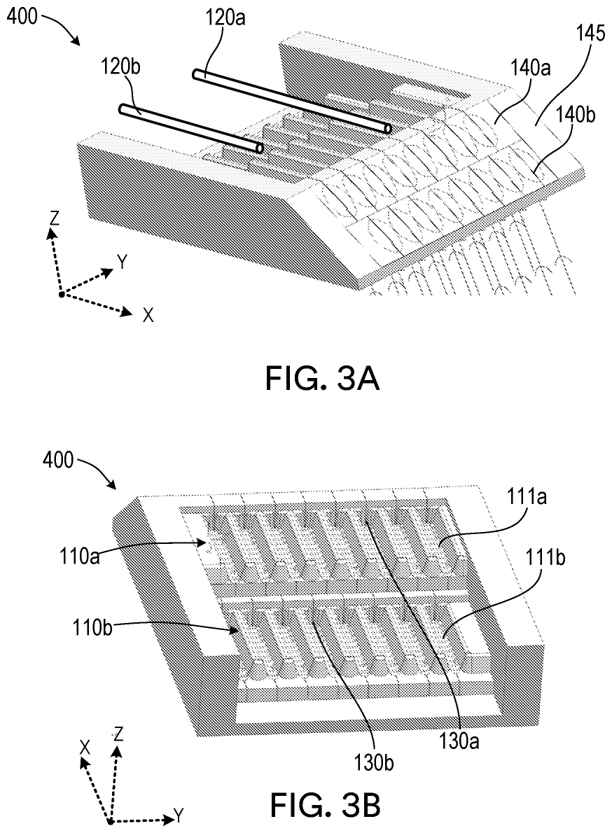

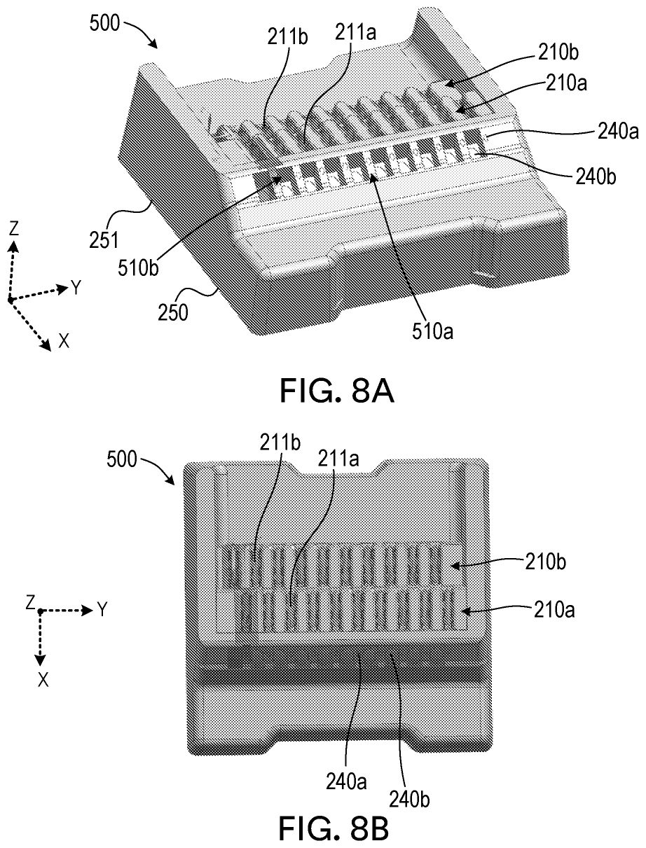

FIGS. 2A and 2B are perspective views of an embodiment of a tandem optical ferrule 300 according to the present description. FIGS. 3A and 3B provide perspective views of an alternate embodiment of a tandem optical ferrule 400 according to the present description. FIGS. 8A and B provide perspective views of a third embodiment of a tandem optical ferrule 500 according to the present description. Each of these embodiments will be discussed separately herein.

Turning back to FIGS. 2A and 2B, and examining the two figures together, a unitary optical ferrule 300 includes a plurality of rows of receiving elements, including at least first row 10a of first receiving elements 11a, and second row 10b of second receiving elements 11b. In some embodiments, first receiving elements 11a and second receiving elements 11b of optical ferrule 300 may extend along a same length direction (e.g., the x-axis shown in FIG. 2A) and arranged along an orthogonal same width direction (e.g., the y-axis shown in FIG. 2A). In some embodiments, first receiving elements 11a and second receiving elements 11b may be substantially parallel relative to each other. In some embodiments, second row 10b of second receiving elements 11b may be offset relative to first row 10a of first receiving elements 11a along a thickness direction (e.g., the z-axis shown in FIG. 2A) orthogonal to the length and width directions. In some embodiments, first receiving elements 11a and second receiving elements 11b may receive and secure respective first 20a and second 20b optical fibers.

In some embodiments, unitary optical ferrule 300 may further include first 30a and second 30b input members (e.g., input surfaces) offset relative to each other along the length direction (e.g., in the x-direction shown in FIG. 2B). In some embodiments, unitary optical ferrule 300 may also further include first 40a and second 40b light redirecting members.

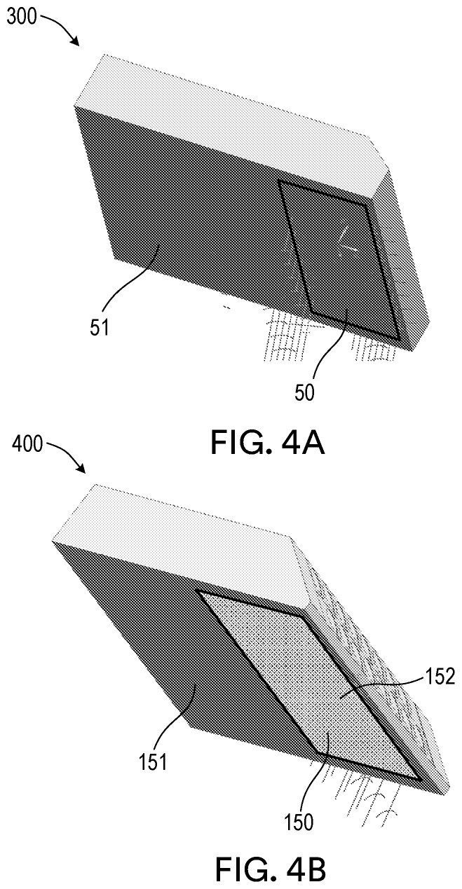

In some embodiments, a central light ray leaving first 20a or second 20b optical fibers will enter optical ferrule 300 through first 30a or second 30b input member respectively. After entering input member 30a and/or 30b, the entered central light ray may be redirected by the respective light redirecting member 40a/40b from a first direction to a different, second direction. The redirected central light rays may then exit unitary optical ferrule 300 through an exit window (e.g., see exit window 50 in FIG. 4A).

In the embodiment of unitary optical ferrule 300 of FIGS. 2A and 2B, the first 30a and second 30b input members and first 40a and second 40b light redirecting members may define a recess 310 therebetween. In some such embodiments, an entered central light ray entering optical ferrule 300 through first input member 30a may pass through recess 310 before being redirected by the first light redirecting member 40a. In contrast, a central light ray entering optical ferrule 300 via second input member 20b will not pass through recess 310 as it will be redirected by second light redirecting member 40b before reaching recess 310. Additional discussions of the optical path of light rays from optical fibers entering the optical ferrule are provided elsewhere herein.

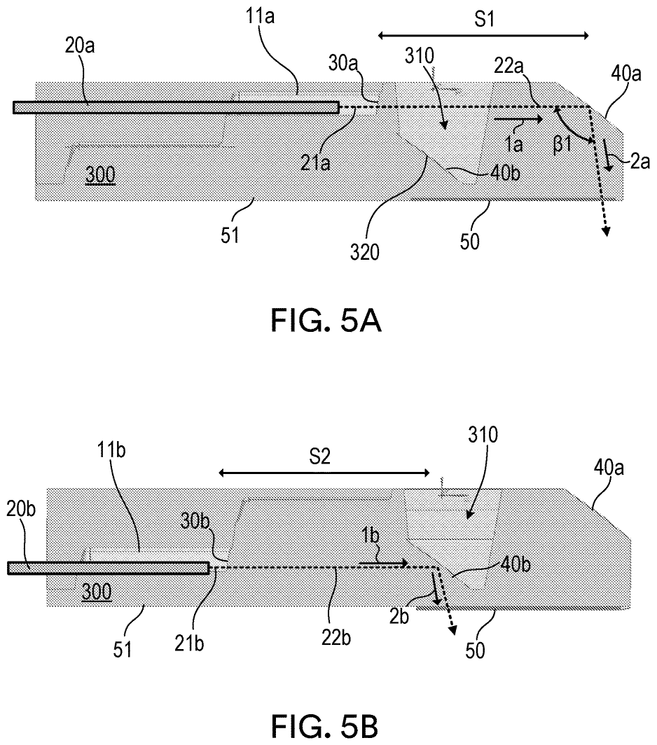

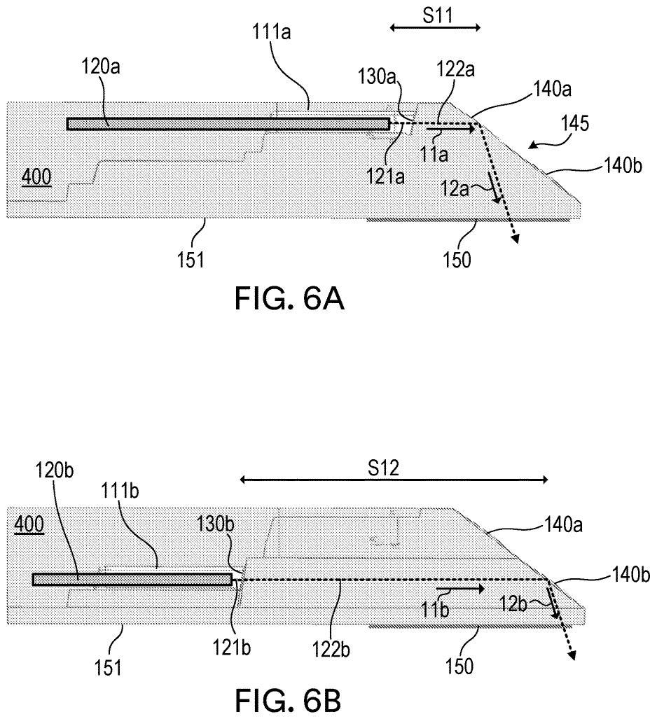

FIGS. 3A and 3B provide perspective views of an alternate embodiment of a tandem optical ferrule 400 according to the present description. Although there are similarities between the embodiment of optical ferrule 300 of FIGS. 2A and 2B and tandem optical ferrule 400, a primary difference between embodiment 300 and embodiment 400 revolves around the positioning of the light redirecting members. While the light redirecting members 40a and 40b of optical ferrule 300 were disposed in two separate, but substantially parallel, planes, separated by recess 310, light redirecting members 140a and 140b are disposed in a same plane with no recess between them. As will be discussed elsewhere herein, this difference in configuration leads to a difference in the distance traveled by the entered central light rays between the input members and the light redirecting members. That is, the difference in distance traveled between the input members and the light redirecting members in optical ferrule 300 is substantially identical no matter if the entering light ray is from an optical fiber in the first row of first receiving elements or an optical fiber in the second row of second receiving elements. On the contrary, for optical ferrule 400, the distance traveled for a light ray entering from the first row of first receiving elements may be significantly different than the distance traveled for a light ray entering from the second row of second receiving elements. See, for example, the discussion of FIGS. 5A, 5B, 6A, and 6B, elsewhere herein.

Turning back to FIGS. 3A and 3B, and examining the two figures together, a unitary, tandem optical ferrule 400 includes a plurality of rows of receiving elements, including at least first row 110a of first receiving elements 111a, and second row 110b of second receiving elements 111b. In some embodiments, first receiving elements 111a and second receiving elements 111b of optical ferrule 400 may extend along a same length direction (e.g., the x-axis shown in FIG. 3A) and arranged along an orthogonal same width direction (e.g., the y-axis shown in FIG. 3A). In some embodiments, first receiving elements 111a and second receiving elements 111b may be substantially parallel relative to each other. In some embodiments, second row 110b of second receiving elements 111b may be offset relative to first row 110a of first receiving elements 111a along a thickness direction (e.g., the z-axis shown in FIG. 3A) orthogonal to the length and width directions. In some embodiments, first receiving elements 111a and second receiving elements 111b may receive and secure respective first 120a and second 120b optical fibers.

In some embodiments, unitary optical ferrule 400 may further include first 130a and second 130b input members (e.g., input surfaces) offset relative to each other along the length direction (e.g., in the x-direction shown in FIG. 3B). In some embodiments, unitary optical ferrule 400 may also further include first 140a and second 140b light redirecting members.

In some embodiments, a central light ray leaving first 120a or second 120b optical fibers will enter optical ferrule 400 through first 130a or second 130b input member respectively. After entering input member 130a and/or 130b, the entered central light ray may be redirected by the respective light redirecting member 140a/140b from a first direction to a different, second direction. The redirected central light rays may then exit unitary optical ferrule 400 through an exit window (e.g., see exit window 150 in FIG. 4B).

In the embodiment of unitary optical ferrule 400 of FIGS. 3A and 3B, first 140a and second 140b light redirecting members may be disposed on a substantially same plane. As the substantially same plane (see surface 145, FIG. 3A) is disposed at an angle relative to the thickness direction (e.g., the z-axis of FIG. 3A), the light rays redirected by first light redirecting member 140a and second light redirecting member 140b will be directed to and exit from different locations (at least partially offset from one another) on exit window 150 (see FIGS. 6A and 6B).

FIGS. 4A and 4B provide further perspective views of embodiments 300 and 400 of a tandem optical ferrule, according to the present description. These views are provided to show bottom, perspective views of optical ferrules 300 and 400. In FIG. 4A, optical ferrule 300 includes a bottom surface 51 opposite and substantially parallel to first 10a and second rows 10b (as shown in at least FIG. 2B). In some embodiments, bottom surface 51 includes exit window 50. Similarly, FIG. 4B shows optical ferrule 400 includes a bottom surface 151 opposite and substantially parallel to first 110a and second rows 110b (as shown in at least FIG. 3B). In some embodiments, bottom surface 151 includes exit window 150. In some embodiments, such as the embodiment shown in FIG. 4B (but not limited to this embodiment), exit window 151 may include an anti-reflection coating 152 disposed thereon to reduce a reflection of an incident light having a wavelength of greater than about 500 nm, or about 600 nm, or about 700 nm, or about 800 nm, or about 900 nm, or about 1000 nm by at least 1%, or by at least 2%, or by at least 3%.

FIGS. 5A and 5B provide side, cutaway views of the embodiment of tandem optical ferrule 300 of FIGS. 2A and 2B. FIGS. 6A and 6B provide side, cutaway views of the embodiment of tandem optical ferrule 400 of FIGS. 3A and 3B. This group of figures will illustrate the optical path taken by light rays emitted by optical fibers as they are redirected through the body of the optical ferrule, and the differences between the embodiments.

Looking first and FIGS. 5A and 5B together, when the first 20a and second 20b optical fibers are received by and secured in the respective first 11a and second 11b receiving elements, first 21a and second 21b central light rays emitted by the respective first 20a and second 20b optical fibers enter unitary optical ferrule 300 through respective first 30a and second 30b input members. In some embodiments, the entered first 22a and second 22b central light rays may then be redirected by respective first 40a and second 40b light redirecting members from first directions la and 1b to different second directions 2a and 2b. In some embodiments, the redirected first 22a and second 22b central light rays exit unitary optical ferrule 300 through the exit window 50 in bottom surface 51 of optical ferrule 300.

In some embodiments, a distance traveled by the entered first central light ray 22a between the first input member 30a and first light redirecting member 40a may be S1 (see FIG. 5A), and a distance traveled by the entered second central light ray 22b between the second input member 30b and second light redirecting member 40b may be S2 (see FIG. 5B). In some embodiments, S1 and S2 may be within about 20%, or within about 15%, or within about 10%, or within about 5% of each other. Stated another way, the distances S1 and S2 may be substantially identical in some embodiments for optical ferrule embodiment 300.

In some embodiments, when the entered first 22a and second 22b central light rays are redirected by the respective first 40a and second 40b light redirecting members from first directions la, 1b to different second directions 2a, 2b, and the redirected first 22a and second 22b central light rays exit the unitary optical ferrule 300 through exit window 50, the first input member 30a and first light redirecting member 40a define a recess 310 therebetween. In some embodiments, an inner wall 320 of recess 310 includes second light redirecting member 40b. In some embodiments, the corresponding first 1a, 1b and second 2a, 2b directions may make an angle β1 of between about 30 degrees and about 150 degrees therebetween.

Turning now to FIGS. 6A and 6B together, and embodiment 400 of the unitary optical ferrule, when first 120a and second 120b optical fibers are received by and secured in the respective first 111a and second 111b receiving elements, first 121a and second 121b central light rays emitted by the respective first 120a and second 120b optical fibers enter unitary optical ferrule 400 through respective first 130a and second 130b input members. In some embodiments, the entered first 122a and second 122b central light rays may then be redirected by respective first 140a and second 140b light redirecting members from first directions 11a and 11b to different second directions 12a and 12b. In some embodiments, the redirected first 122a and second 122b central light rays exit unitary optical ferrule 400 through the exit window 150 in bottom surface 151 of optical ferrule 400.

In some embodiments, a distance traveled by the entered first central light ray 122a between the first input member 130a and first light redirecting member 140a may be S11 (see FIG. 6A), and a distance traveled by the entered second central light ray 122b between the second input member 130b and second light redirecting member 140b may be S12 (see FIG. 6B). In some embodiments, S11 and S12 may be different by at least 30%, or at least 40%, or at least 50%, or at least 60%, or at least 70%, or at least 80%, or at least 90%, or at least 100%. In some embodiments, a size of first light redirecting member 140a may be significantly different (e.g., smaller) than a size of second light redirecting member 140b. In such embodiments, this may be possible because of the relative difference in the distance traveled of the light rays, and the relative difference in light spread of the light rays as they travel different distances. In some embodiments, the corresponding first 11a, 11b and second 12a, 12b directions may make an angle β1 of between about 30 degrees and about 150 degrees therebetween (as shown in FIG. 5B, but applicable to optical ferrule 400, as well). In some embodiments, first light redirecting member 140a and second light redirecting member 140b may be disposed in a same plane (e.g., same planar surface) 145.

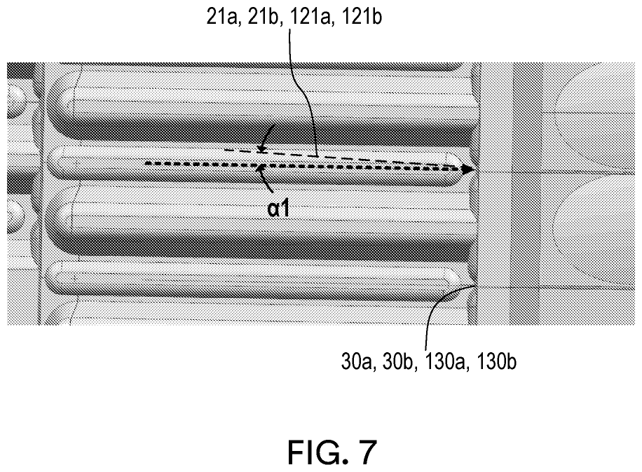

FIG. 7 illustrates the angle of incidence of central light rays on the input member of an optical ferrule. Light rays traveling through an optical fiber travel via the mechanism of total internal reflection. Stated another way, a light ray injected into an optical fiber is propagated through the fiber because the light ray strikes the internal walls of the fiber at an angle greater than or equal to the critical angle (the minimum angle a which total internal reflection occurs, rather than the light being transmitted out of the fiber). As a result of this “bouncing” through an optical fiber, each of the central light rays (e.g., rays 21a, 21b, 121a, or 121b of FIGS. 5A, 5B, 6A, or 6B) emitted by the first and second optical fibers may be incident on the corresponding input member (e.g., rays 30a, 30b, 130a, or 130b of FIGS. 5A, 5B, 6A, or 6B) at an incident angle al of greater than about 0.5 degrees, or greater than about 1 degree, or greater than about 1.5 degrees, or greater than about 2 degrees, or greater than about 3 degrees, or greater than about 4 degrees, or greater than about 5 degrees.

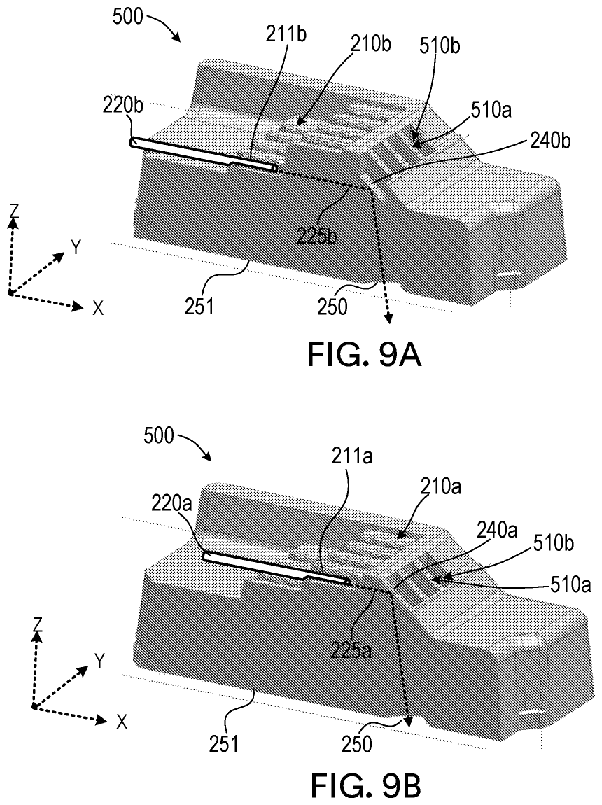

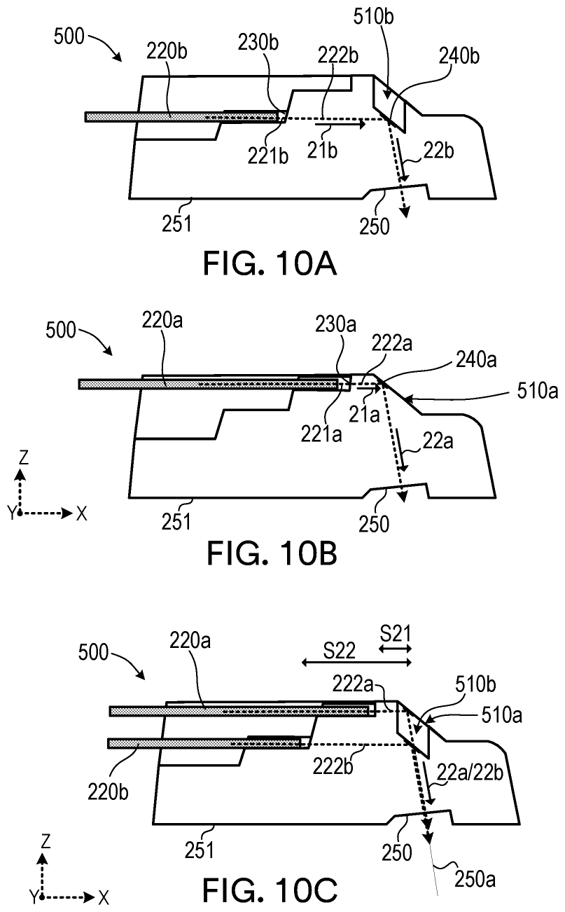

FIGS. 8A and 8B (as well as FIGS. 9A-9B and 10A-10C), provide views of a third embodiment 500 of a tandem optical ferrule according to the present description. Similar to the previous discussion of embodiments 300 and 400 of the optical ferrule, embodiment 500 has many features in common to these embodiments, with a primary difference being in the configuration of the light redirecting surfaces. Embodiments 300 and 400 of the unitary, tandem optical ferrule provide an increased density in the number of output light rays by staggering the location of the output rays (e.g., to match the staggered pattern of I/O ports on a PIC shown on FIG. 1B). In the embodiment 500 of the unitary, tandem optical ferrule, the light redirecting surfaces are configured such that the resulting output light rays match the denser, non-staggered pattern of I/O ports on a PIC, such as the pattern of I/O ports shown in FIG. 1C.

In some embodiments, unitary optical ferrule 500 includes a plurality of rows comprising at least first 210a and second 210b rows of respective substantially parallel first 211a and second 211b receiving elements, first 230a and second 230b input members offset relative to each other along the length direction, a plurality of first light redirecting members 240a alternating with a plurality of second 240b light redirecting members, and an exit window 250 (disposed on a bottom surface 251 of optical ferrule 500).

In some embodiments, the first 211a and second 211b receiving elements may extend along a same length direction (e.g., the x-axis) and arranged along an orthogonal same width direction (e.g., the y-axis) for receiving and securing respective first 220a and second 220b optical fibers. In some embodiments, the second row 210b of the second receiving elements 211b may be offset relative to the first row 210a of first receiving elements 211a along a thickness direction (e.g., the z-axis of FIG. 8A) orthogonal to the length and width directions.

In some embodiments, each second light redirecting member 240b may be disposed in a recess 510b relative to each corresponding first light redirecting member 240a disposed on a non-recessed surface 510a. In some embodiments, an average size of the first light redirecting members 240a and an average size of the second light redirecting members 240b may be different by at least 10%, or at least 20%, or at least 25%, or at least 30%, or at least 35%, or at least 50%, or at least 100%, or at least by a factor of 3, or at least by a factor of 4. As will be explained in the discussion of the remaining figures, this configuration of smaller light reflecting members 240a alternating with larger light reflecting members 240b recessed relative to light reflecting members 240a allow the light rays exiting optical ferrule 500 through exit window 250 to be disposed within a same plane (to match the non-staggered pattern of I/O ports illustrated in FIG. 1C).

FIGS. 9A and 9B provide additional perspective (cutaway) views of a tandem optical ferrule, for example, the alternate embodiment of optical ferrule 500 of FIGS. 8A and 8B. FIGS. 9A and 9B, as well as FIGS. 10A-10C, are cutaway views allowing the path of a central light ray through the ferrule. These figures have many elements common to the previous figures and it shall be assumed these like-numbered components serve the same function unless otherwise specified herein. The primary focus of the following discussion will be on the path of light rays emitted by optical fibers 220a, 220b.

In some embodiments, unitary optical ferrule 500 includes first 211a and second 211b receiving elements configured for receiving and securing respective first 220a and second 220b optical fibers. In some embodiments, the second row 210b of the second receiving elements 211b may be offset relative to the first row 210a of first receiving elements 211a along a thickness direction (e.g., the z-axis) orthogonal to length and width directions of the optical ferrule.

In some embodiments, a central light ray 225a, 225b emitted by optical fiber 220a, 220b enters optical ferrule 500 and is redirected by the corresponding light redirecting member 240a, 240b. Central light ray 225a, 225b is redirected such that it exists optical ferrule 500 through exit window 250 in bottom surface 251. The plurality of light redirecting members 240a are disposed on a surface 510a that alternates with and is offset from the plurality of light redirecting members 240b, which are disposed in recesses 510b.

FIGS. 10A-10C provide schematic, cutaway views which further illustrate the optical path followed by central light rays emitted by optical fibers 220a and 220b. Looking first at FIG. 210A, a central light ray 221b is emitted by optical fiber 220b and enters optical ferrule 500 through input member 230b. Entered central light ray 222b travels through optical ferrule 500 in a first direction 21b and is redirected by light redirecting member (e.g., a mirror) 240b (disposed in recess 510b) toward a different, second direction 22b and finally exits optical ferrule 500 through exit window 250.

Similarly, turning now to FIG. 210B, central light ray 221a is emitted by optical fiber 220a and enters optical ferrule 500 through input member 230a. Entered central light ray 222a travels through optical ferrule 500 in a first direction 21a and is redirected by light redirecting member (e.g., a mirror) 240a (disposed on surface 510a) toward a different, second direction 22a and finally exits optical ferrule 500 through exit window 250.

By alternating light redirecting members 240a disposed on surface 510a with light redirecting members 240b disposed in recesses 510b, light redirecting members 240a and 240b can be configured to redirect exiting light rays 222a and 222b so that they leave exit 250 disposed in a same plane 250a (shown as seen from on end), as shown in FIG. 10C (which is a composite of FIGS. 10A and 10B, showing both sets of central light rays). By “lining up” the exiting light rays in a same plane, optical ferrule can be used with a pattern of I/O ports on an interfacing PIC device such as that shown in FIG. 1C, effectively doubling the number of I/O ports that can be used in the system (in this example). FIG. 10C also shows that a distance traveled by light ray 21a between input member 230a and light redirecting member 240a, S21, is less than a distance traveled by light ray 21b between input member 230b and light redirecting member 240b for this embodiment.

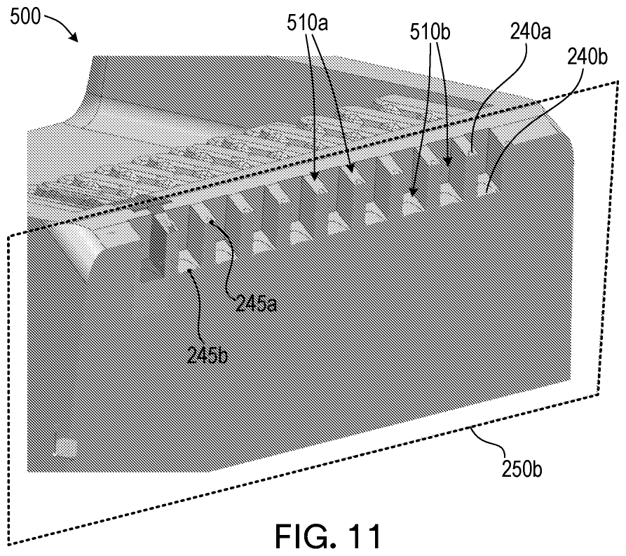

The alternating light redirecting members may better be seen in FIG. 11, which is another cutaway view of optical ferrule 500, showing the ferrule cut along a second plane 250b, which passes through center points 245a and 245b on the pluralities of first 240a and second 240b light redirecting members. In some embodiments, this plane 250b may be substantially orthogonal to the planar surfaces of both light redirecting members 240a and 240b. This arrangement allows light rays (such as entered light rays 21a, 21b) to be redirected in a same plane (such as plane 250a, shown in FIG. 10C) and impinge on a row of I/O ports similar to the pattern of I/O ports shown in FIG. 1C.

It should be noted, by looking at FIGS. 10C and 11, it can be seen that the shorter travel distance S21 for light rays traveling between input member 230a and light redirecting member 240a (shorter relative to distance S22 for light rays traveling between input member 230b and light redirecting member 240b) means that light rays traveling the smaller distance, S21, will spread less than corresponding light rays traveling greater distance S22. Because of this, light redirecting members 240a can be significantly smaller than corresponding light redirecting members 240b, as shown at least in FIG. 11.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed:

1. A unitary optical ferrule comprising:
a plurality of rows comprising at least first and second rows of respective substantially parallel first and second receiving elements extending along a same length direction and arranged along an orthogonal same width direction for receiving and securing respective first and second optical fibers, the second row of the second receiving elements offset relative to the first row of the first receiving elements along a thickness direction orthogonal to the length and width directions;
first and second input members offset relative to each other along the length direction;
first and second light redirecting members; and
an exit window, such that when the first and second optical fibers are received by and secured in the respective first and second receiving elements, first and second central light rays emitted by the respective first and second optical fibers enter the unitary optical ferrule through the respective first and second input members, the entered first and second central light rays are redirected by the respective first and second light redirecting members from first directions to different second directions, and the redirected first and second central light rays exit the unitary optical ferrule through the exit window.

2. The unitary optical ferrule of claim 1, wherein a distance traveled by the entered first central light ray between the first input and light redirecting members is S1 and a distance traveled by the entered second central light ray between the second input and light redirecting members is S2, and wherein S1 and S2 are within 20% of each other.

3. The unitary optical ferrule of claim 1, wherein a distance traveled by the entered first central light ray between the first input and light redirecting members is S11 and a distance traveled by the entered second central light ray between the second input and light redirecting members is S12, and wherein S11 and S12 are different by at least 30%.

4. The unitary optical ferrule of claim 1, wherein the second row of the second receiving elements is offset relative to the first row of the first receiving elements along the thickness direction by at least 5 microns.

5. The unitary optical ferrule of claim 1, wherein each of the first and the second rows comprises at least two receiving elements.

6. The unitary optical ferrule of claim 1, wherein each of the first and second receiving elements comprises a groove extending along the length direction.

7. The unitary optical ferrule of claim 1, wherein the first and the second input members are offset relative to each other along the length direction by at least 10 microns.

8. The unitary optical ferrule of claim 1, wherein the first and the second light redirecting members are offset relative to each other along the length direction and along the thickness direction.

9. The unitary optical ferrule of claim 1 further comprising a bottom surface opposite and substantially parallel to the first and the second rows, the bottom surface comprising the exit window.

10. The unitary optical ferrule of claim 1, wherein each of the central light rays emitted by the first and second optical fibers is incident on the corresponding input member at an incident angle of greater than about 0.5 degrees.

11. The unitary optical ferrule of claim 1, wherein the entered first and second central light rays are redirected by the respective first and second light redirecting members by at least 40 degrees.

12. The unitary optical ferrule of claim 1, wherein the corresponding first and second directions make an angle of between about 30 and 150 degrees therebetween.

13. The unitary optical ferrule of claim 1, wherein each of the redirected first and second central light rays exits the unitary optical ferrule through the exit window at a different location of the exit window.

14. The unitary optical ferrule of claim 1, wherein an average size of the first light redirecting members and an average size of the second light redirecting members is different by at least 10%.

15. The unitary optical ferrule of claim 1, wherein the second light redirecting members alternate with the first light redirecting members across the width direction of the optical ferrule, and each of the second light redirecting members is disposed in a recess relative to the each of the first light redirecting members.
